(19) United States
(12) Patent Application Publication
(10) Pub. No.: US 2009/0094719 A1
(43) Pub. Date: Apr. 16, 2009

(54) FIBRE TREATMENT RESIN AND METHOD OF PREPARING SUCH RESIN

(75) Inventor: Chee Seng Norman LIM, Singapore (SG)

Correspondence Address: SUGHRUE MION, PLLC, 2100 PENNSYLVANIA AVENUE, N.W., SUITE 800, WASHINGTON, DC, 20037, US

(73) Assignee: FRAL Private Limited, Singapore (SG)

(21) Appl. No.: 12/251,049

(22) Filed: Oct. 14, 2008

(30) Foreign Application Priority Data
Oct. 12, 2007 (SG) 200716923-8

(51) Int. Cl. F41H 1/02; C08L 67/00; C08K 3/28; C08G 63/00; B05D 3/02; B32B 27/36; B32B 27/34

(52) U.S. Cl. 2/2.5; 524/599; 524/428; 528/271; 428/375; 442/135; 428/395; 428/394; 427/385.5

(57) ABSTRACT

A method of preparing fibre treatment resin is disclosed herein. In a preferred embodiment, at step 100, the method comprises dispersing ethyl acetic acid copolymers in water to form a mixture at predetermined temperature and at step 102, ammonia is introduced as a flocculent into the mixture to form a suspension; and at step 104, the suspension is cooled to form the fibre treatment resin. Fibres treated with the fibre treatment resin exhibits improved tenacity and enable the fibres to be stretched and absorb the energy of incidental pressure such as those from a projectile.

### BACKGROUND AND FIELD OF THE INVENTION

This invention relates to fibre treatment resin and method of preparing such resin, which is, particularly but not exclusively, useful for ballistic applications.

It is well known that fibre travel is a problem relating to woven fabrics utilizing high performance yarns like HPPE, para-aramids, PBO, M5 and polypropylene. This is because when point pressure is applied to the woven fabric, fibre travel weakens the tenacity of woven fabrics where the point pressure is applied.

To address this problem, and to improve fabric fibre travel problems, weavers use plain weave and tighter woven methods to stabilise the fabrics. For high performance fabrics, the maximum strength in a yarn or fibre is achieved when the long crystalline structures are disturbed or interrupted as little as possible, preferably, left untouched. With weaving, the yarns are subjected to high stress levels caused by weaving machines coupled with bending over weft yarns by wrap ones. Such an action can typically weaken the yarns' tenacity by as much as up to 50%.

An improved weaving technology has been proposed to address the above problem by utilising two or more layers of fabric arranged in adjacent 90° angles to each other and a third axis yarn is used to weave the fabric layers together to achieve the maximum tenacity since this does not involve bending the main roving yarns. Such a technology gives good anti-de-lamination properties for composite fabrics making it one of the best raw materials available in the marketplace. However, this weaving technology requires expensive machinery and thus high investments are needed for large scale adoption. As a result, there is high reluctance for some weavers to adopt this technology.

Other resin/tape technology to make non-woven fabrics are available and one such technology uses parallel filaments laid close to each other to sandwich layers of filaments to form layers of uni-directional tapes for ballistic applications. Such a technique allows maximum yarn strengths to be exploited. However, to achieve good ballistic performance, specialised high pressure presses are required to keep the yarn layers as close as possible together. Further, as in soft composite applications, the layers of tapes need to be stitched together to stabilise the layers as the surface of the tapes is extremely smooth. Aramid made this way tends to have uneven delaminating areas between the tack tape and the filaments during cutting and assembly of the fabric. Stitching of the aramid fibres also pushes the filaments aside creating a weak point in the fabric.

Matrix and bonding have also been used to produce fabrics with improved pressure resistance and cut/stab resistance. An example proposes the use of plastic films pressed at elevated temperatures. The presence of the film allows the fabric to be more stable, and yet the film melts and delaminates under pressure to release the fibres allowing elongations. The melting and de-lamination also absorbs energy. The use of the film to reinforce the fabric enables the fabric to be very stab resistant but the film may add up to 60% of the weight of the fabric depending on the composition. Further, problems associated with the use of such films are long production cycles, restrictions on the sizes of fabric cause wastage and high production costs. Also, the flexibility of the fabric suffers greatly if the film is used in great layers stacked together.

It is an object of the present invention to provide fibre treatment resin and a method of preparing such a resin which addresses at least one of the disadvantages of the prior art and/or to provide the public with a useful choice.

### SUMMARY OF THE INVENTION

In a first aspect of the invention, there is provided a method of preparing fibre treatment resin, the method comprising the steps of:

(i) dispersing ethyl acetic acid copolymers in liquid medium at predetermined temperature; (ii) adding a flocculent to the dispersed polymer to form a suspension; and (iii) allowing the suspension to cool to a temperature lower than the predetermined temperature to form the fibre treatment resin.

In a second aspect of the invention, there is provided fibre treatment resin comprising ethyl acetic acid copolymer.

The fibre treatment resin may then be used to reinforce fibres and this forms a third aspect of the invention in which there is provided a method of reinforcing fibres comprising the step of: (i) treating the fibres with fibre treatment resin comprising ethyl acetic acid copolymer and a flocculent.

A further aspect of the invention relates to the final product and this relates to fibre treated with fibre treatment resin comprising ethyl acetic acid copolymer.

Ethyl acetic acid copolymer has been found to exhibit excellent phase change properties and when fibre treated with fibre treatment resin including such a copolymer, the fibre is able to be stretched under incidental pressure (such as incidental pressure from a projectile) so that the fibre is able to absorb the energy from the incidental pressure. In this way, the treated fibre can be used for armour or body protection against ballistic or stab threats.

Preferably, the amount of copolymer to amount of liquid medium ratio is between 5% and 45% of total volume. Preferably, the amount of copolymer to amount of liquid medium ration is between 22% and 38% of total volume.

The amount of flocculent may be between 0.05 and 0.5% of liquid medium introduced.

The predetermined temperature may be between 15° C. and 100° C. under 5 bars of pressure.

A preferred flocculent is ammonia but sodium hydroxide and potassium hydroxide may also be used. A preferred liquid medium is water.

Appropriate storage of the fibre treatment resin extends the shelf life of the fibre treatment resin and preferred temperatures of between 15° C. and 40° C. may allow the resin to be stored for up to 18 months.

The fibre treatment resin preferably comprises 5 to 45 weight % of ethyl acetic acid copolymer and 0.05 to 0.5 weight % of flocculent.

After treating fibres or fabric with the fibre treatment resin, it is necessary to dry the treated fibres to evaporate the flocculent and liquid medium and a preferred drying method is to use convection air at a temperature between 50° C. and 75° C. Advantageously, the temperature is about 65° C.

Once dried, the amount of fibre treatment resin in the fibres or fabric is 4% to 20% over pre-treatment fibre weight.

The fibre or fabric treated with the proposed fibre treatment resin is particularly useful for ballistic applications such as used in a stab or bullet resistant vest.

It is envisaged that if a plurality of fabric or fibre layers are used, then at least one of the fabric or fibre layers is treated with fibre treatment resin comprising ethyl acetic acid copolymer to enhance the ballistic performance of the layers. Of course, more or all of the layers may be treated with the resin.

The fabric or fibre layers may be selected from the group consisting of para aramid (poly(p-phenylene terephthalamide)), para aramid-poly(p-phenylene terephthalamide), poly(m-xylene adipene), poly(p-xylene sebacamide), aliphatic polyamides, cycloaliphatic polyamides, copolyamide of 30% bis(amidocyclohexyl) methylene, terephthalic acid, caprolactum, polyhexamethylene adipamide, liquid crystal polyesters, benzimidazole like M5 and oxazoles.

Examples of cycloaliphatic polyamides may be 30% hexamethylene diammonium isophathalate with 70% hexamythylene diammonium adipate and an example of oxazoles is ZYLON PBO.

### BRIEF DESCRIPTION OF THE DRAWINGS

An embodiment of the invention will now be described, by way of example, with reference to the accompanying drawings in which,

FIG. 1 is a flow chart illustrating steps for preparing a fibre treatment resin and for treating a fabric with the fibre treatment resin;

FIG. 2 is a table providing test data of ballistic testing ordinary plain woven fabric compared to 10% treated fabrics; and

FIG. 3 is a table providing test data of ballistic testing of plain woven fabric untreated, treated and satin fabric treated tenacity tests.

### DETAILED DESCRIPTION OF THE PREFERRED EMBODIMENT

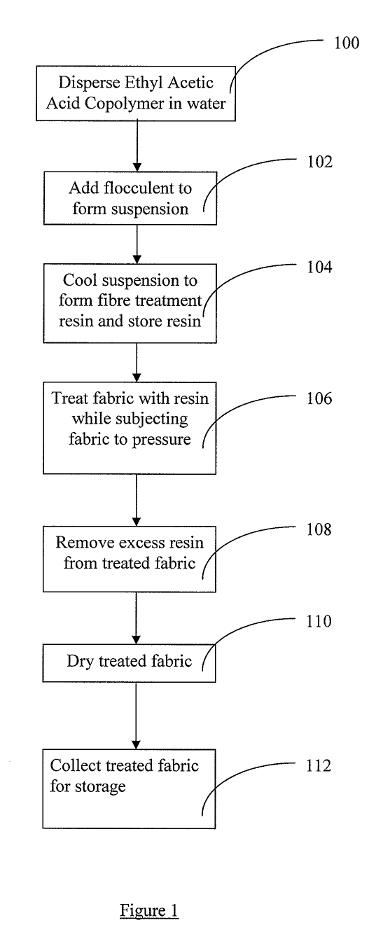

Referring to FIG. 1, at step 100, a mixture of ethyl acetic acid copolymer and pressurised heated water is placed in a container and the container is placed in a pressurised chamber. The temperature of the heated water is 100° C. and under 5 bars of pressure at least. The water ratio to copolymer ratio is from 5% to 45% of total mass of the mixture.

The ethyl acetic acid copolymer is then ultrasonically dispersed in the mixture at elevated temperatures.

At step 102, ammonia is introduced as a flocculent into the mixture to prevent settling of the nano-particulate of the ethyl acetic acid. The amount of ammonia introduced is about 0.5% of the total volume of the mixture to form a homogenous suspension fluid.

At step 104, the suspension fluid is allowed to cool naturally to room temperature to form a fibre treatment resin and then transferred to a polyethylene container and stored at a temperature of about 20° C. When suitably stored, the fibre treatment resin may have a shelf life of up to 18 months.

The storage temperature is preferably between 15° C. and 40° C. If the storage temperature is lower than 15° C., the fibre treatment resin may become unstable over time. If the storage temperature is above 40° C., the fibre treatment resin may destabilise and cause precipitation.

To impregnate fibres with the fibre treatment resin, apparatus used for the treatment is similar to water repellent treatment machinery available in most composite material weaving plants. In this embodiment, a layer of aramid is to be treated with the resin, and the apparatus includes a tank for holding the suspension, a conveyor system for carrying the layer of aramid into the tank through an inlet at one end of the tank and for carrying the layer of aramid out of the tank through an outlet at the other end of the tank, and pressure rollers disposed within the tank and arranged along the path of the conveyor system.

The fibre treatment resin is first poured into the tank and at step 106, and a layer of aramid fibre is rolled into the tank by the conveyor system so that the layer of aramid fibre is fully submerged in the suspension. The pressure rollers are then used to out-gas any air trapped in the layer of aramid to achieve even and thorough impregnation of the suspension. In this way, the layer of aramid is treated or impregnated with the copolymeric resin.

The apparatus further includes two doctoring blades positioned at the outlet of the tank and as the treated aramid layer emerges out of the tank, the doctoring blades remove superfluous resin from the treated aramid layer at step 108 so that the superfluous resin is channeled back to the tank. The doctoring blades are preferably made of steel or rubber and the pressure and angle of the blades are configured to calibrate desired matrix content in the resultant treated aramid layer.

Thereafter, at step 110, the treated aramid layer is subjected to convection air at an elevated temperature of 65° C. to dry up the water medium and ammonia flocculent. Once dried, the resin is bonded to the fibres or to put in the other way, the fibres are impregnated with the resin. The period of submergence of the aramid layer in the tank and the pressure of out-gassing by the rollers determines the degree of bonding or impregnation of the resin.

After drying, at step 112, the treated aramid layer is either dusted with talcum powder or interlaced with paper and roll-collected at the end for storage. The use of powder and paper is to prevent the ethyl acetic acid copolymer from tacking to each adjacent layer when stacked packed and stored in hot exposed containers during shipping.

Preferable, looms should be pack in open cell polymer foam or polyethylene foam as an insulating packaging before shipping.

Using the polymer resin including ethyl acetic acid copolymer to treat the aramid layer, this enables improved energy absorption of the aramid fibres via phase change during a ballistic event. This also improves the pressure resistance performance of the aramid fibre. The improvement in the tenacity of the aramid layer is achieved without special stitching of the fibres and this creates a matrix system of impregnation of fibres to achieve stability so that high tenacity weave with low stability patterns like crowfoot and satin or uni-directional roving material can be used for applications previously not suited for.

Further, it can be appreciated that the process of preparing the copolymer resin utilizes existing machinery commonly found in the industry to achieve impregnation, without the need for sophisticated and expensive equipment.

To provide an improvement over standard fabrics with an option of pressure heat pressing the treated fabrics to produce hard plates without the need for introducing additional resins and matrix systems. In other words, pressure heated pressing allows fibres/fabrics treated with the fibre treatment resin to form a hard plate like a prepreg. This gives an armour maker convenience to store and use the same inventory for either soft or hard armour without a need to have alternative prepregs stored at sub-zero temperatures with short life spans. In this way, the described embodiment also enables manufacturers to lower inventory costs.

The treated aramid layer can be used for a multitude of applications ranging from aerospace, ballistic application and construction industry etc in view of the phase change property of the treated aramid layer.

To elaborate, the treated aramid layer is particularly useful in ballistic applications since the tenacity of the aramid locks surrounding yarns or fibres so that when a projectile strikes a spot of the treated aramid layer, the surrounding yarns or fibres participate to reducing the speed of the projectile. Further, elongation/stretching by the fibres and conversion of kinetic energy to heat (for sub-sonic bullets) and the pressure exerted on the spot of impact melts the polymeric matrix and releases the yarn to stretch further without locking it out like normal stitch would. Thus, the stretching of the yarn absorbs more energy of the projectile in the process of phase change of the resin.

The use of the polymer resin also eliminates the need of stitching adjacent layers to increase fabric stability but this reduces back face signatures in a ballistic event. Also, as discussed earlier, stitching has drawbacks in reducing V50 value of the eventual failure of the fibre layer if the pattern is too tight. However, if the stitching is too loose, it loses its back face signature reduction.

Further, tests has shown that the treated aramid layer displayed superior stability, allowing aramid to be used in 8H satin woven styles and unidirectional roving mats for ballistic applications. Tests conducted showed marginal improvement of fabric tenacity, particularly in the oblique directions. Hitherto, 8H satin fabrics are seldom used in ballistic packages due to their lateral weakness in stability even though their breaking strength far exceeds the plain and crowfoot weaves. With the proposed invention, it is possible to maximise the potential of this weave that retains the linearity of the crystalline structures within the yarns for force absorption bringing to bear their maximum effectiveness second only to unwoven uni-directional fabrics.

The treated aramid layers may also be pressed in a hot press at 150 deg Celsius to form hard plates for composite and armour applications. For example, 20 layers of hard pressed Twaron® CT709 showed good stopping power to ammunition from a Magnum 357 with trauma back face values lower than 20 mm and knife stab resistance to 36J on the P1B blade, properties, otherwise, not possible with such fabrics.

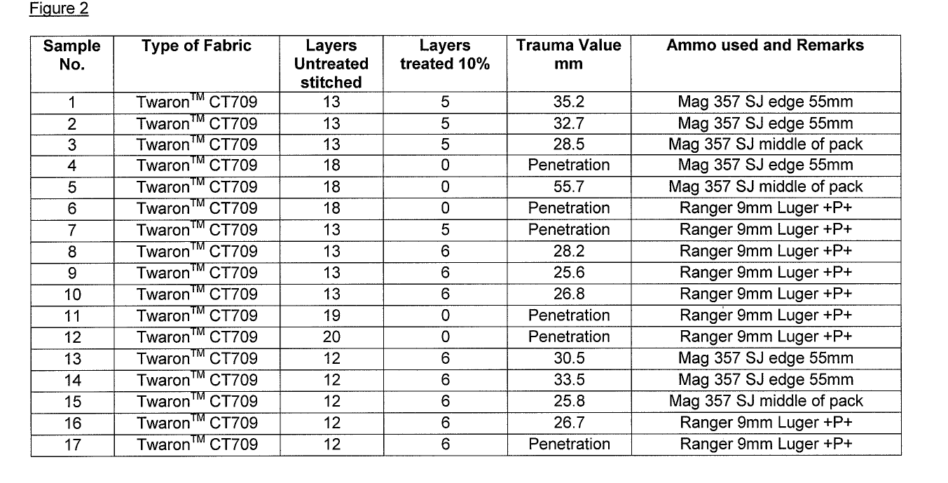

FIG. 2 is a table providing test data of ballistic testing ordinary plain woven fabric compared to 10% treated fabrics.

Two samples of 13 layers and 12 layers of Twaron™ CT709 which is a 930 dtex Twaron™ 2040 para-aramid fabric are used as test samples. Fabric is plain weave 25×25 wert and wrap per inch.

Referring to FIG. 2, sample (1) is shot with Magnum 357 semi jacketed round compliant to NIJ standards in the US Department of Justice. This package consists of 18 layers, 5 treated with the dilatant polymer of this invention, and 13 untreated. This is compared to 18 layers of stitched materials. The performance of the package with 5 layers treat fabric exhibited superior force absorption even at the edge. While the untreated model exhibited failure in trauma values as they are higher than the passing mark of 44 mm. The edge shot is similarly failure due to penetration by the ammunition.

Samples (6) and (7) were shot with Ranger 9 mm Luger +P+ and as shown in FIG. 2, both packages were not able to stop the bullets from the gun.

By adding a layer of treated fabric at the back of the package, (i.e. Samples (8), (9) and (10), it is possible to stop the 9 mm Luger +P+ consistently. However, plain untreated fabrics are not sufficient to stop the ammunition even at 20 layers.

When we shoot 12 layers stitched package with 6 layers of treated fabric, as represented by Samples (13) to (17), there is slight improvement in trauma values, showing that the present invention contributes to trauma reduction properties for Magnum 357 ammunition. However, for 9 mm Luger +P+, it is surprising to note that even at a higher velocity there is are some penetrations and some stoppages even with 18 layers at total compared to the package shot earlier with 13 untreated and 5 treated ones. This shows that there may be an improvement of the V50 value of the package if some layers of treated materials are increased by ratio while remaining the number of material layers constant.

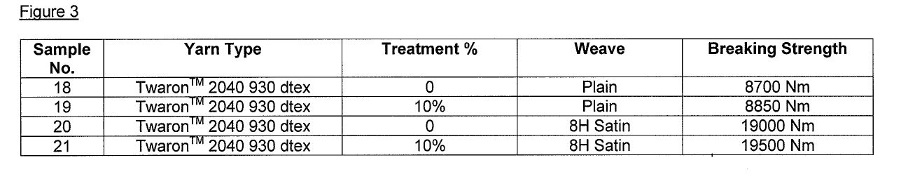

FIG. 3 is a table providing test data of ballistic testing of plain woven fabric untreated, treated and satin fabric treated tenacity tests. As it would be appreciated, impregnation of the copolymer ethyl acetic acid seems to yield a marginal result, but yet, in 8H satin, it allowed such fabrics to be utilised in ballistic packages, hitherto not possible. Thus, it saves an armour designer costly material to produce superior ballistic packages.

From the test data in FIGS. 1 and 2, it can be appreciated that treating fibres with ethyl acetic acid improves the tenacity of the fibres and also their ballistic characteristics.

The described embodiment should not be construed as limitative. For example, if the ethyl acetic acid copolymer that is used come in pallets, the form commonly available, then the copolymer should be melted prior to being dispersed in water.

At step 104 of the described embodiment, the suspension fluid is allowed to cool naturally to room temperature. However, the cooling may be carried by force cooling or external heat exchange means, whichever method that is appropriate.

Preferably, the resin to water content is between 15% and 40% resin content of total volume. More preferably, the range should be between 22% and 38% of total volume to prevent the polymer to be coagulated,

Other suitable flocculent may be used, not just ammonia, for example, sodium hydroxide and potassium hydroxide although these flocculent may cost more. Basically, any alkali type flocculent may be used. Also, the amount of flocculent may be adjusted according need and application. However, if ammonia is used, then preferably, the ammonia content is between 0.03% and 1% of total volume of the mixture. Advantageously the amount of ammonia is between 0.3% and 0.56%.

Of course, the invention is applicable to other fibres, not just aramid. For example, M5 and non plastic yarns in loom state or greige state may similarly be treated with the ethyl acetic acid resin.

In the described embodiment, the temperature for the air convection is chosen to be 65° C. but the temperature may be between 40° C. and 80° C. Also, the rate of heating is dependent on humidity and ambient temperature and if humidity is above 90%, it has been found that 70° C. is preferred.

In the described embodiment, the ethyl acetic acid copolymer is ultrasonically dispersed but other dispersion techniques such as mono-dispersion, bi-dispersion may be used.

Having now fully described the invention, it should be apparent to one of ordinary skill in the art that many modifications can be made hereto without departing from the scope as claimed.

1. A method of preparing fibre treatment resin, the method comprising the steps of:
dispersing ethyl acetic acid copolymer in liquid medium at predetermined temperature;
adding a flocculent to the dispersed polymer to form a suspension; and
allowing the suspension to cool to a temperature lower than the predetermined temperature to form the fibre treatment resin.

2. A method according to claim 1, wherein the amount of copolymer to amount of liquid medium ratio is between 5% and 45% of total volume.

3. A method according to claim 1, wherein the amount of copolymer to amount of liquid medium ration is between 22% and 38% of total volume.

4. A method according to claim 1, wherein the amount of flocculent is between 0.05 to 0.5% of liquid medium introduced.

5. A method according to claim 1, wherein the predetermined temperature is between 15° C. and 100° C. under 5 bars of pressure.

6. A method according to claim 1, wherein the flocculent is ammonia.

7. A method according to claim 1, wherein the liquid medium is water.

8. Fibre treatment resin comprising ethyl acetic acid copolymer.

9. Fibre treatment resin according to claim 8, further comprising 5 to 45 weight % of ethyl acetic acid copolymer and 0.05 to 0.5 weight % of flocculent.

10. A method of reinforcing fibres comprising the step of:
treating the fibres with fibre treatment resin comprising ethyl acetic acid copolymer and a flocculent.

11. A method according to claim 10 further comprising the step of drying the treated fibre.

12. A method according to claim 11, wherein the drying step includes subjecting the treated fibre to convection air at a temperature between 50° C. and 75° C.

13. A method according to claim 12, wherein the temperature is about 65° C.

14. Fibre treated with fibre treatment resin comprising ethyl acetic acid copolymer.

15. Fibre according to claim 14, wherein the amount of fibre treatment resin is 4% to 20% over pre-treatment fibre weight.

16. A stab or bullet resistant vest comprising the fibre of claim 14.

17. A plurality of fabric or fibre layers, at least one of the fabric or fibre layers treated with fibre treatment resin comprising ethyl acetic acid copolymer.

18. A plurality of fabric or fibre layers according to claim 17, wherein the fabric or fibre is selected from the group consisting of para aramid (poly(p-phenylene terephthalamide)), para aramid-poly(p-phenylene terephthalamide), poly(m-xylene adipene), poly(p-xylene sebacamide), aliphatic polyamides, cycloaliphatic polyamides, copolyamide of 30% bis(amidocyclohexyl) methylene, terephthalic acid, caprolactum, polyhexamethylene adipamide, liquid crystal polyesters, benzimidazole like M5 and oxazoles.
